(19) United States
(12) Patent Application Publication
(10) Pub. No.: US 2025/0330893 A1
(43) Pub. Date: Oct. 23, 2025

(54) CONTROLLER SUB-CLUSTER SELECTION BY A NETWORK DEVICE AFTER A CLUSTER SPLIT

(71) Applicant: HEWLETT PACKARD ENTERPRISE DEVELOPMENT LP, Spring, TX (US)

(72) Inventors: Jinzhao Ren, Beijing (CN); Chunfeng Wang, Beijing (CN); Raghunandan Prabhakar, Bangalore (IN); Zhijun Ren, Beijing (CN)

(21) Appl. No.: 18/765,901

(22) Filed: Jul. 8, 2024

(30) Foreign Application Priority Data
Apr. 19, 2024 (IN) 202441031335

(51) Int. Cl. H04W 40/24; H04W 28/08

(52) U.S. Cl. CPC H04W 40/248; H04W 28/0925

(57) ABSTRACT

In some examples, a network device determines that a cluster split has occurred in which a controller cluster of controllers is split into a plurality of sub-clusters. The network device receives, from the plurality of sub-clusters, information associated with controllers of the plurality of sub-clusters. The network device selects, from among the plurality of sub-clusters, a sub-cluster to which the network device is to connect using a specified criterion.

### BACKGROUND

Client devices can communicate data with a computing environment through network devices of a network arrangement. Examples of network devices include switches, wireless access points (APs), gateways, concentrators, or other network devices.

### BRIEF DESCRIPTION OF THE DRAWINGS

Some implementations of the present disclosure are described with respect to the following figures.

FIG. 1 is a block diagram of an arrangement including controller cluster that is connected to multiple access points (APs) to which a client device can establish wireless connectivity in accordance with some examples.

FIG. 2 is a flow diagram of a process performed in response to a controller cluster split, according to some examples.

FIG. 3 is a block diagram of a network device according to some examples.

FIG. 4 is a block diagram of a storage medium storing machine-readable instructions according to some examples.

FIG. 5 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In some examples, a network arrangement can include network devices and associated controllers that perform various functions with respect to the network devices or client devices that are connected to the network devices. For example, APs may be connected to controllers that perform management tasks for the APs. Client devices are able to wirelessly connect to APs that are part of one or more wireless networks. Once a client device has associated with (established a connection with) an AP, the client device can establish a communication session with another endpoint device through the AP.

A controller that performs management functions for an AP may be referred to as an AP anchor controller (AAC). A controller that performs management functions for client devices that have associated with APs may be referred to as a user anchor controller (UAC). For example, a UAC can perform any or some combination of the following: association or disassociation notification (in which the UAC provides a notification to a remote entity that a client device has associated with or disassociated from an AP), authentication (in which the UAC authenticates a client device), routing traffic between the UAC and a client device, or other functions.

In some cases, controllers may be arranged as part of a controller cluster. For example, the controller cluster may include multiple AACs and/or multiple UACs. A given AP can be connected to an active AAC (A-AAC) and a standby AAC (S-AAC). If the given AP loses a connection to the A-AAC (due to failure of the A-AAC or failure of a communication link to the A-AAC), the S-AAC detects the failure and initiates a process to failover the AP to the S-AAC. The multiple UACs of the controller cluster may include an active UAC (A-UAC) and a standby UAC (S-UAC) for a given client device. If the given client device loses a connection to the A-UAC, then a failover can be initiated to failover the given client device to the S-UAC.

Connectivity between controllers in a controller cluster may be lost, which may cause a cluster split in which the controller cluster is divided into multiple sub-clusters. As a result of a cluster split, different APs may connect to different sub-clusters. For example, after the cluster split, a first AP may connect to a first sub-cluster, cluster, while a second AP may connect to a second sub-cluster. The different sub-clusters may have different UACs. If a client device were to roam from the first AP to the second AP after the cluster split, since the first and second APs are connected to different sub-clusters with different UACs, there would be no session information for the client device after the client device roams from the first AP to the second AP. After the client device has roamed to the second AP, traffic of the client device may be forwarded by the second AP to the second sub-cluster; however, since the sessions are not synchronized between the first and second sub-clusters and various parameters for the client device may not be up-to-date in the second sub-cluster, user experience is not seamless and the traffic handling behavior may not be as expected. For example, the traffic of the client device may be dropped in the second sub-cluster, or the traffic may be sent to a wrong destination.

In accordance with some implementations of the present disclosure, after a cluster split occurs, controllers of the sub-clusters can send controller information (e.g., in the form of a node list) to APs to inform the APs of which controllers are in the respective sub-clusters. A node list includes information of a collection of nodes within a cluster. After a cluster split, a node list from a given sub-cluster includes identification of a collection of nodes in the sub-cluster. A “node” can refer to a computing system implemented with one or more computers. A node can include an AAC or a UAC, or both an AAC and a UAC. In response to the node lists from the sub-clusters, an AP can select, using a collection of criteria, a sub-cluster from among the sub-clusters to which the AP is to connect. A “collection of criteria” can include a single criterion or multiple criteria. Multiple APs connected to the controller cluster prior to the cluster split can use the same collection of criteria to ensure that each of the APs selects the same sub-cluster after the cluster split. By using the same collection of criteria in making the sub-cluster selection, the multiple APs effectively use a common technique or algorithm to deterministically select the same sub-cluster from multiple sub-clusters. As a result, communications of client devices roaming among multiple APs following the cluster split would be properly handled by the selected sub-cluster, since the selected sub-cluster would include session information for the client devices due to the APs being connected to the same sub-cluster.

Although reference is made to AACs and UACs in some examples discussed herein, it is noted that techniques or mechanisms according to some implementations of the disclosure can be applied with other types of controllers. More generally, an AAC is an example of a network device controller that performs management functions for a network device such as an AP or a switch.

A UAC is an example of a client device controller that performs management functions for a client device, such as those listed further above for the UAC, or any other type of management function that relates to connections of a client device to a network device, authentication of a client device, or routing of data between the client device controller and a client device.

A “network device” refers to a communication device within a network (wireless network or wired network) responsible for forwarding data of client devices through network paths of the network. An AP is an example of a network device that is able to establish wireless connectivity with client devices. A switch is an example of a network device that is able to establish wired connectivity with client devices.

A “client device” refers to an electronic device that is capable of establishing a communication session over a network. Examples of electronic devices include any or some combination of the following: computers (e.g., desktop computers, notebook computers, tablet computers, etc.), smartphones, Internet of Things (IoT) devices, vehicles, household appliances, communication nodes, storage systems, or other types of electronic devices.

A network device controller can send information that identifies controllers in a cluster of controllers. An example of such information includes a node list as discussed further above. The network device controller may also send association information that associates client devices with client device controllers. In the case where the network device controller is an AAC, the association information may be in the form of a bucket map in which identities of client devices (e.g., network addresses such as Media Access Control (MAC) addresses of client devices) are associated with respective one or more UACs. The bucket map ensures that any given client device is associated with the same UAC regardless of which network device (e.g., AP or switch) the given client device is connected to. A “bucket map” can be in the form of mapping information that correlates each client device to a respective UAC. In some examples, a bucket map can include multiple entries, where each entry contains information identifying an A-UAC and an S-UAC. An entry of the bucket map is indexed based on a network address (e.g., MAC address) of a client device.

In an example involving APs, a client device may roam between different APs as the client device physically moves around. The client device may be initially wirelessly connected to a source AP, and due to movement of the client device, the client device may establish a wireless connection with a target AP and possibly drop its wireless connection with the source AP. Such a process is referred to as roaming. When the client device roams between different APs, a bucket map can ensure that the client device uses the same UAC regardless of which AP the client device is connected to. More specifically, the target AP to which the client device has roamed can use the bucket map to determine the UAC that is to be used for the client device. This UAC can perform management functions for the client device as discussed further above.

In another example involving switches, a client device may be physically moved between different locations, in which case the client device's wired connection may change from a first switch to a second switch (i.e., the client device is disconnected from the first switch and connected to the second switch). Association information may ensure that the client device uses the same client device controller even though the client device has changed connections between different switches.

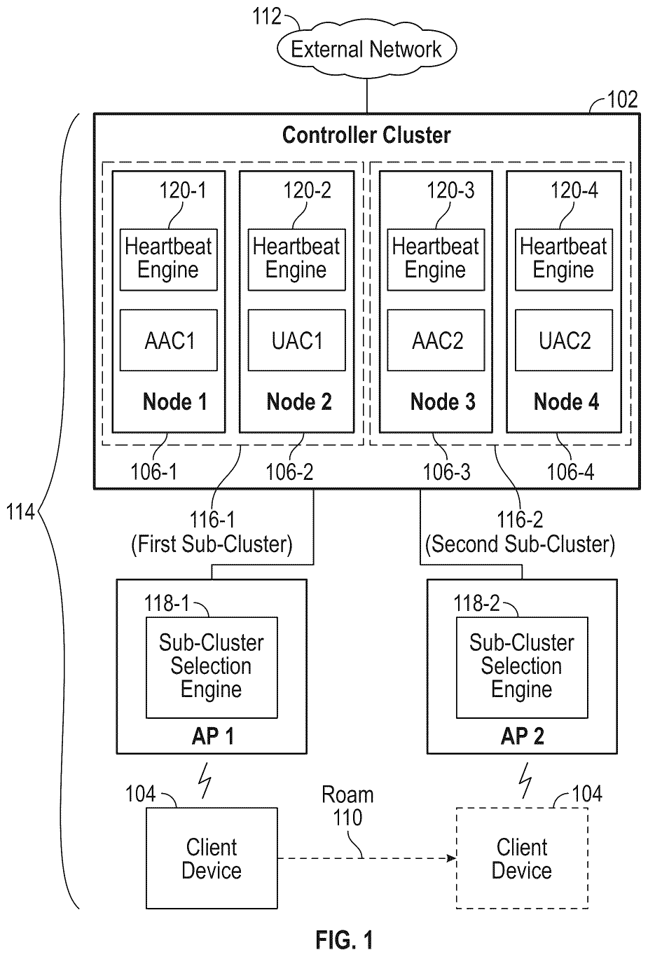

FIG. 1 is a block diagram of an example arrangement that includes a controller cluster 102 and APs (AP 1 and AP 2 depicted in the example). Although FIG. 1 shows an example that includes APs, in other examples, other types of network devices such as switches can be used to connect to a client device 104. In other examples, multiple client devices can connect to the APs or other types of network devices.

The controller cluster 102 includes multiple nodes, where a node can include just an AAC, or just a UAC, or both an AAC and a UAC. In the example of FIG. 1, the controller cluster 102 includes nodes 106-1, 106-2, 106-3, and 106-4. The node 106-1 includes a first AAC (AAC1), and the node 106-3 includes a second AAC (AAC2). The node 106-2 includes a first UAC (UAC1), and the node 106-4 includes a second UAC (UAC2). Note that in other examples, there may be more nodes than depicted in FIG. 1 in the controller cluster 102.

A “controller” that is in a node can refer to the combination of machine-readable instructions and the processing resource (including one or more processors) in the node that are used to implement the controller. In a node with multiple controllers, the multiple controllers can be implemented with respective combinations of machine-readable instructions and the processing resources in the node.

Each AP 1 and AP 2 can establish a connection with each controller in the nodes 106-1 to 106-4 of the controller cluster 102. A connection between an AP and a controller can include a tunnel that is established between the AP and the controller. In some examples, for a given AP, one of the AACs (AAC1 and AAC2) in the controller cluster 102 is an active AAC (A-AAC), while the other one of the AACs in the controller cluster 102 is a standby AAC (S-AAC). AP 1 and AP 2 may have the same A-AAC or different A-AACs, and similarly, AP 1 and AP 2 may have the same S-AAC or different S-AACs.

A connection between an AP and an A-AAC is referred to as an active connection (e.g., an active tunnel), while a connection between the AP and an S-AAC is referred to as a standby connection (e.g., a standby tunnel). A tunnel can include an Internet Protocol Security (IPsec) tunnel, for example. In other examples, other types of tunnels or more generally connections can be established between an AP and a controller.

In some examples, for any given client device, one of the UACs of the controller cluster 102 is an active UAC (A-UAC), while another UAC of the controller cluster 102 is a standby UAC (S-UAC). Different client devices may be assigned different A-UACs and S-UACs. Alternatively, different client devices may be assigned to the same A-UAC and S-UAC. The assignment of a client device to a UAC can be represented by a bucket map as discussed above.

An AP can failover from an A-AAC to an S-AAC if the AP loses a connection to the A-AAC. Similarly, a client device can failover from an A-UAC to an S-UAC if the client devices loses a connection to the A-UAC.

The assignment of an A-UAC and an S-UAC from the controller cluster 102 to a given client device can be performed by a leader node, which can be one of the nodes 106-1 to 106-4. For example, an administrator may select one of the nodes 106-1 to 106-4 as the leader node. As another example, the nodes 106-1 to 106-4 can perform an election process to elect one of the nodes 106-1 to 106-4 as the leader node. Once the leader node has assigned UACs to client devices, the leader node can generate a bucket map that represents this assignment. The leader node then sends the bucket map to the other nodes of the controller cluster 102.

After a connection (e.g., a tunnel) is established between an AP and the leader node, the leader node can select an A-AAC (as well as the corresponding S-AAC) for the AP. The selected A-AAC sends a node list and the bucket map to the AP. When a client device sends traffic to the AP, the AP uses the bucket map received from the A-AAC to determine the A-UAC for the client device, and the traffic of the client device can be directed to the A-UAC.

As shown in FIG. 1, the client device 104 can roam (at 110) from AP 1 to AP 2, for example. After the client device 104 connects to AP 2, the client device 104 continues to be associated with the same A-UAC (e.g., one of UAC1 or UAC2), since both AP 1 in AP 2 received the bucket map that associates the A-UAC with the client device 104. As a result, after roaming from AP 1 to AP 2, the client device 104 remains anchored at the same A-UAC, so that the A-UAC can continue to perform management functions for the client device 104.

The A-UAC can route data of the client device 104 to an external network 112, such as the Internet or another type of external network. The external network 112 is external to an infrastructure 114 that includes the controller cluster 102, the APs, and client devices.

In accordance with some examples of the present disclosure, each AP includes a sub-cluster selection engine to select a sub-cluster of the controller cluster 102 after a cluster split occurs that results in multiple sub-clusters being formed. The cluster split may be due to loss of connectivity between nodes of the controller cluster 102. FIG. 1 shows an example in which a cluster split of the controller cluster 102 results in a first sub-cluster 116-1 and a second sub-cluster 116-2. Each sub-cluster can include a subset of nodes of the controller cluster 102. For example, the sub-cluster 116-1 includes nodes 106-1 and 106-2, and the sub-cluster 116-2 includes nodes 106-3 and 106-4. The nodes of the sub-cluster 116-1 are not part of the sub-cluster 116-2, and similarly, the nodes of the sub-cluster 116-2 are not part of the sub-cluster 116-1. Effectively, after the cluster split, the first sub-cluster 116-1 includes AAC1 and UAC1 in the respective nodes 106-1 and 106-2, and the second sub-cluster 116-2 includes AAC2 and UAC2 in the respective nodes 106-3 and 106-4.

In the example of FIG. 1, AP 1 includes a sub-cluster selection engine 118-1, and AP 2 includes a sub-cluster selection engine 118-2. As used here, an “engine” can refer to one or more hardware processing circuits, which can include any or some combination of a microprocessor, a core of a multi-core microprocessor, a microcontroller, a programmable integrated circuit, a programmable gate array, or another hardware processing circuit. Alternatively, an “engine” can refer to a combination of one or more hardware processing circuits and machine-readable instructions (software and/or firmware) executable on the one or more hardware processing circuits. A sub-cluster selection engine in an AP can determine that a cluster split has occurred in which the controller cluster 102 is split into multiple sub-clusters. The sub-cluster selection engine can receive, from nodes in the sub-clusters, information associated with controllers of the sub-clusters. More specifically, the sub-cluster selection engine can receive a node list from each sub-cluster, where a node list from a given sub-cluster identifies the nodes that are part of the sub-cluster (or more specifically, information that identifies controllers in the nodes of the sub-cluster).

A sub-cluster selection engine in a given AP is responsible for selecting a sub-cluster from among the multiple sub-clusters 116-1 and 116-2 to which the given AP is to connect following the cluster split of the controller cluster 102. The selection of the sub-cluster from the multiple sub-clusters is based on a collection of criteria. The sub-cluster selection engines 118-1 and 118-2 in AP 1 and AP 2 (and any other sub-cluster selection engines in other APs) can use the same collection of criteria for selecting a sub-cluster from among the multiple sub-clusters 116-1 and 116-2 following the cluster split. Since the sub-cluster selection engines in different APs use the same collection of criteria, the sub-cluster selection engines in the different APs would select the same sub-cluster following the cluster split.

For example, following the cluster split that produces the sub-clusters 116-1 and 116-2, the sub-cluster selection engines 118-1 and 118-2 would both select the sub-cluster 116-1, in which case both AP 1 and AP 2 would connect to the sub-cluster 116-1 in response to the cluster split.

In this scenario, the other sub-cluster 116-2 would remain unused by AP 1 and AP 2. Note that the cluster split may be a temporary condition during which the nodes of the sub-cluster 116-2 are unused by APs. If connectivity between the nodes 106-1 to 106-4 of the controller cluster 102 were to be re-established at a later time, the nodes of the sub-cluster 116-2 can rejoin with the nodes of the sub-cluster 116-1, at which point the full controller cluster 102 would become available again.

In some examples, the collection of criteria used by each sub-cluster selection engine can include any or some combination of the following: a criterion based on the capacity of a sub-cluster; a criterion based on a network address of a node in a sub-cluster; a criterion based on a health of a sub-cluster; a criterion based on a load of a sub-cluster; a criterion based on a performance of a sub-cluster; or any other criteria.

In some examples, the criterion based on the capacity of a sub-cluster can include a criterion based on a count of nodes including controllers in the sub-cluster. The assumption here can be that a sub-cluster with a greater quantity of nodes (and thus controllers) would have a greater capacity than another sub-cluster with fewer nodes.

Alternatively or additionally, the criterion based on the capacity of a sub-cluster can include a criterion based on how many stations (including client devices and APs) a sub-cluster can support. For example, each node can include configuration information indicating the maximum quantity of stations (including client devices and APs) that can be supported by the node. A sub-cluster selection engine can access this configuration information of nodes in each sub-cluster to determine which sub-cluster is able to handle more stations-this sub-cluster has a greater capacity.

If the capacities of multiple sub-clusters are the same, then a sub-cluster selection engine can use another criterion to select from among the multiple sub-clusters. The capacities of multiple sub-clusters are the same if the capacities are within a threshold range of one another. This other criterion can be the criterion based on a network address of a node in a sub-cluster. The nodes of a sub-cluster are assigned respective network addresses, such as MAC addresses or Internet Protocol (IP) addresses. The sub-cluster selection engine can compare the network addresses of the nodes 106-1 and 106-2 in the first sub-cluster 116-1 to the network addresses of the nodes 106-3 and 106-4 in the first sub-cluster 116-2. The sub-cluster selection engine can determine which sub-cluster has the node with the lowest (or alternatively, the highest) network address, and this sub-cluster can be selected as the sub-cluster to which the AP is to connect.

Another criterion that can be used by a sub-cluster selection engine in performing a sub-cluster selection can be the criterion based on a health of a sub-cluster. The “health” of a sub-cluster refers to a condition of the nodes of the sub-cluster that is indicative of whether or not the nodes may experience faults. For example, monitoring agents in the nodes of the sub-cluster may monitor certain health metrics (e.g., a count of a quantity of errors detected, a count of dropped packets, etc.). The sub-cluster selection engine can use the health metrics to determine the health of the sub-cluster. When selecting from among multiple sub-clusters, the sub-cluster selection engine can select the sub-cluster that has the better health based on the health metrics from the multiple sub-clusters.

Another criterion that can be used by a sub-cluster selection engine in performing a sub-cluster selection can be the criterion based on a load of a sub-cluster. The “load” of a sub-cluster refers to how much of the resources (e.g., processing resources, storage resources, communication resources, programs, or other resources) of nodes of the sub-cluster are being used in performing workloads of the nodes. When selecting from among multiple sub-clusters, the sub-cluster selection engine can select the sub-cluster with a lighter load.

Another criterion that can be used by a sub-cluster selection engine in performing a sub-cluster selection can be the criterion based on a performance of a sub-cluster. The “performance” of a sub-cluster refers to how well the nodes of the sub-cluster are performing their workloads, such as based on metrics including a quantity of instructions executed per second, an input/output (I/O) rate, or other performance metrics. When selecting from among multiple sub-clusters, the sub-cluster selection engine can select the sub-cluster with a greater performance.

Although some example criteria are listed above, in other examples, a sub-cluster selection engine can employ alternative or additional criteria.

The nodes 106-1 to 106-4 of the controller cluster 102 also include respective heartbeat engines. For example, the node 106-1 includes a heartbeat engine 120-1, the node 106-2 includes a heartbeat engine 120-2, the node 106-3 includes a heartbeat engine 120-3, and the node 106-4 includes a heartbeat engine 120-4.

A heartbeat engine is responsible for sending heartbeat messages from one node to the other nodes of the controller cluster 102. A “heartbeat message” can refer to any information that is sent on a scheduled basis, such as periodically, from one node to another node. If a first node fails to receive a heartbeat message from a second node within a specified time interval, then that can indicate that a communication loss has occurred between the first and second nodes.

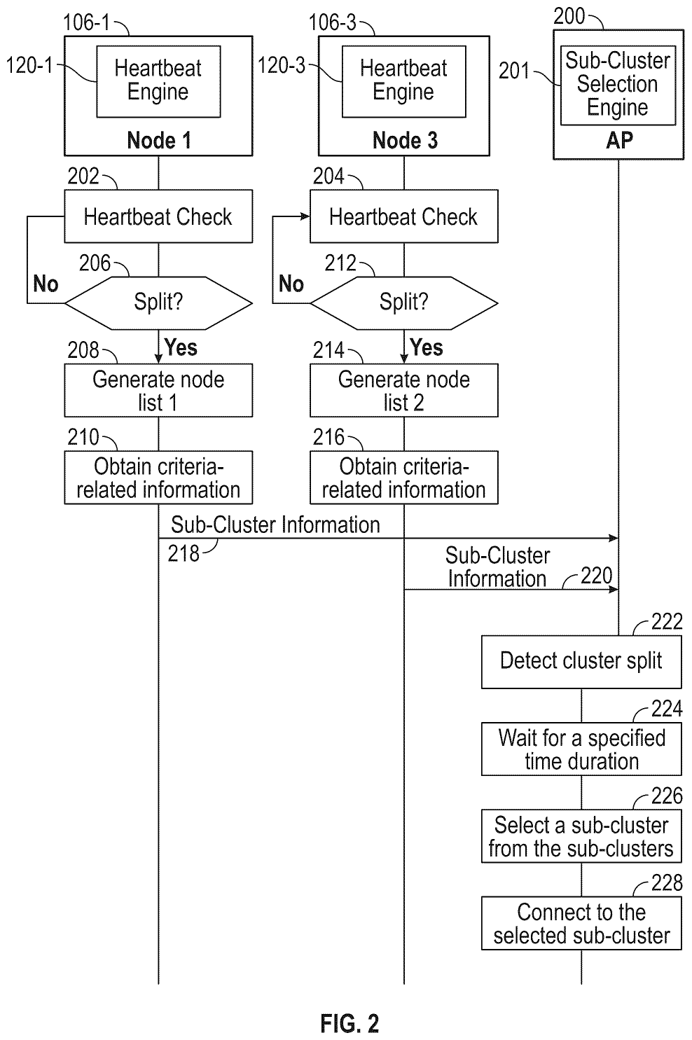

FIG. 2 is a flow diagram of a process that includes detecting a cluster split and taking action in response to the cluster split. The example of FIG. 2 shows tasks of the nodes 106-1 and 106-3 and an AP 200, which can be either AP 1 or AP 2 in FIG. 1. The nodes 106-1 and 106-3 may be the nodes pre-designated (such as by an administrator) to perform cluster split detections. Note that the other nodes 106-2 and 106-4 can similarly detect a cluster split.

As depicted in FIG. 2, the heartbeat engine 120-1 in the node 106-1 performs a heartbeat check (at 202), and the heartbeat engine 120-3 in the node 106-3 performs (at 204) a heartbeat check. Failure to receive a heartbeat message (or a specified quantity of heartbeat messages) from another node can indicate a cluster split has occurred.

The heartbeat engine 120-1 determines (at 206) whether a cluster split has occurred. A cluster split occurs if the node 106-1 detects a heartbeat loss. A heartbeat loss is indicated by the node 106-1 failing to receive a heartbeat message from the node 106-3 within a specified time interval. In some examples, a heartbeat loss is indicated by the node 106-1 failing to receive a specified quantity of heartbeat messages in respective time intervals.

If no cluster split is detected, the heartbeat engine 120-1 returns to perform another heartbeat check (at 202). However, if a cluster split is detected that results in formation of the sub-clusters 116-1 and 116-2, the node 106-1 generates (at 208) node list 1, which identifies the nodes 106-1 and 106-2 of the sub-cluster 116-1. The node 106-1 also obtains (at 210) criteria-related information from the nodes 106-1 and 106-2 of the sub-cluster 116-1 that is to be used by a sub-cluster selection engine in an AP to select from among multiple sub-clusters. “Criteria-related information” can also be referred to as “sub-cluster selection information,” since the information is to be used by a sub-cluster selection engine in selecting a sub-cluster from multiple sub-clusters according to a collection of criteria. The criteria-related information can include any or some combination of the following: information relating to the capacity of the nodes of the sub-cluster 116-1; information of network addresses of the nodes of the sub-cluster 116-1; information relating to the health of the nodes of the sub-cluster 116-1; information relating to the load of the nodes of the sub-cluster 116-1; information relating to the performance of the nodes of the sub-cluster 116-1; or other information relating to criteria to be used in sub-cluster selection by a sub-cluster selection engine in an AP. The criteria-related information can be obtained by retrieving information stored at the nodes of the sub-cluster cluster 116-1 and/or by receiving the information from monitoring agents in the nodes of the sub-cluster 116-1.

Similarly, if the heartbeat engine 120-3 determines (at 212) whether a cluster split has occurred. If no cluster split is detected, the heartbeat engine 120-3 returns to perform another heartbeat check (at 204). If a cluster split is detected, the node 106-3 generates (at 214) node list 2, which identifies the nodes 106-3 and 106-4 of the sub-cluster 116-2. The node 106-3 also obtains (at 216) criteria-related information from the nodes 106-3 and 106-4 of the sub-cluster 116-1 that is to be used by a sub-cluster selection engine in an AP to select from among multiple sub-clusters.

The node 106-1 (and more specifically, AAC1 in the node 106-1) sends (at 218) sub-cluster information to the AP 200. The sub-cluster information sent by the node 106-1 can include node list 1 and the criteria-related information obtained by the node 106-1. More generally, the node 106-1 can send the sub-cluster information to each of the APs connected to the node 106-1. Similarly, the node 106-3 (and more specifically, AAC2 in the node 106-3) sends (at 220) sub-cluster information to the AP 200, as well as each other AP connected to the node 106-3.

Upon receiving the sub-cluster information sent from either the node 106-1 or 106-3, the AP 200 detects (at 222) that a cluster split of the controller cluster 102 has occurred. The detection of the cluster split by the AP 200 (or more specifically, by the sub-cluster selection engine 201 in the AP 200) is based on a determination by the sub-cluster selection engine 201 that a received node list indicates a smaller quantity of controllers (or nodes) in the sub-cluster than present in the controller cluster 102. In other words, if the received node list indicates a smaller quantity of controllers (or nodes) than was indicated by a prior node list received from the controller cluster 102, that would indicate that a cluster split has occurred.

In response to detecting the cluster split, the AP 200 waits (at 224) for a specified time duration for other nodes in other sub-clusters to send their respective sub-cluster information. After the specified time duration expires, the sub-cluster selection engine 201 in the AP 200 selects (at 226), according to the collection of criteria, a sub-cluster from among the sub-clusters 116-1 and 116-2 based on the criteria-related information received from the sub-clusters 116-1 and 116-2. As noted above, the sub-cluster selection can be based on one or more of the following: a criterion based on the capacity of a sub-cluster; a criterion based on a network address of a node in a sub-cluster; a criterion based on a health of a sub-cluster; a criterion based on a load of a sub-cluster; a criterion based on a performance of a sub-cluster; or any other criteria.

Based on the sub-cluster selected by the sub-cluster selection engine 201, the AP 200 connects (at 228) to the selected sub-cluster (or more specifically, to the nodes in the selected sub-cluster). A leader node in the selected sub-cluster can generate a bucket map (that associates client devices to one or more UACs in the selected sub-cluster), and send the bucket map to the AP 200 as well as any other AP connected to the selected sub-cluster. Using this bucket map, for any client device that connects to the AP 200, a UAC in the selected sub-cluster can be used for the client device.

After the cluster split, if the client device 104 were to roam from AP 1 to AP 2 (which are both connected to the same selected sub-cluster), the roaming process of the client device 104 would be seamless since the same bucket map would be available at both AP 1 and AP 2. The roaming is seamless in that the same UAC (identified by the bucket map) would be used after the client device 104 roams from AP 1 to AP 2.

As noted above, after a cluster split, if connectivity between the nodes 106-1 to 106-4 of the controller cluster 102 were to be re-established at a later time, the nodes of the sub-cluster 116-2 can rejoin with the nodes of the sub-cluster 116-1, at which point the full controller cluster 102 would become available again. Assuming the sub-cluster 116-1 is the sub-cluster selected by the sub-cluster selection engines 118-1 and 118-2 of AP 1 and AP 2 in response to the cluster split, the rejoinder of the sub-cluster 116-2 would cause AAC1 in the node 106-1 to send, to AP 1 and AP 2 (as well as any other APs), a node list that identifies the additional nodes 106-3 and 106-4 of the rejoined sub-cluster 116-2. An AP can detect the rejoinder based on the node list received from AAC1 in the selected sub-cluster 116-1 identifying an additional controller (e.g., AAC2 and UAC2 in the nodes 106-3 and 106-4) not in the selected sub-cluster 116-1.

Also, after the rejoinder, the leader node of the controller cluster 102 computes a new bucket map containing the additional UAC, and sends the new bucket map to the APs. Based on the new bucket map, an AP can use UAC2 of the node 106-4 for a client device associated with UAC2 by the new bucket map. Note that when the controller cluster 102 was split, UAC2 was not available since the sub-cluster 116-1 was selected by the APs based on the collection of criteria.

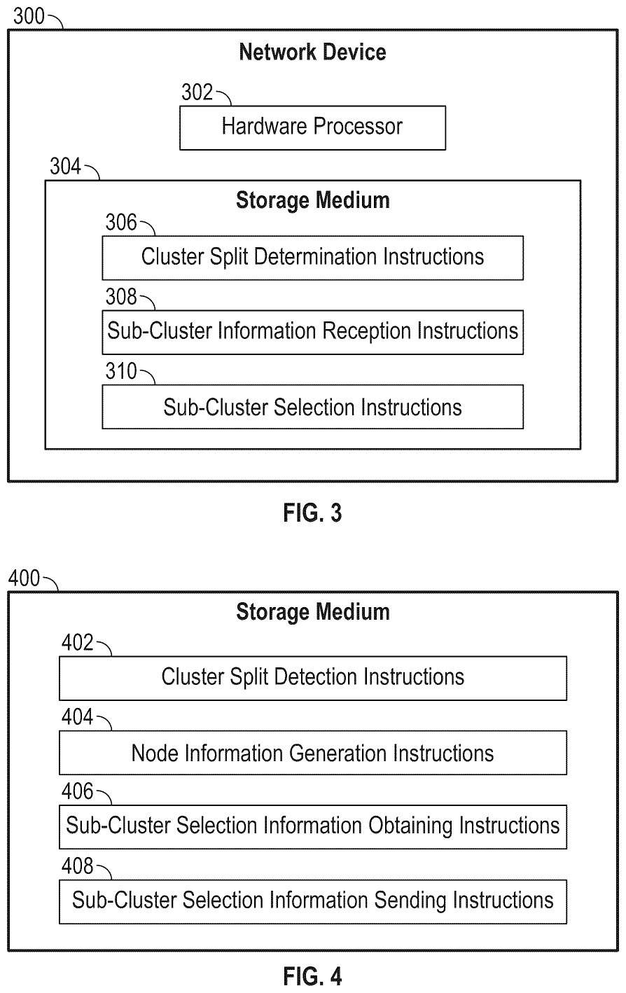

FIG. 3 is a block diagram of a network device 300 according to some examples of the present disclosure. The network device 300 may include an AP or a switch, for example.

The network device 300 includes a hardware processor 302 (or multiple hardware processors). A hardware processor can include a microprocessor, a core of a multi-core microprocessor, a microcontroller, a programmable integrated circuit, a programmable gate array, or another hardware processing circuit.

The network device 300 further includes a storage medium 304 storing machine-readable instructions executable on the hardware processor 302 to perform various tasks. Machine-readable instructions executable on a hardware processor can refer to the instructions executable on a single hardware processor or the instructions executable on multiple hardware processors.

The machine-readable instructions include cluster split determination instructions 306 to determine that a cluster split has occurred in which a controller cluster of controllers is split into a plurality of sub-clusters. For example, after a cluster split, a given node containing a controller can generate node information identifying nodes of a sub-cluster that the given node is part of. If the network device 300 detects that the node information identifies a quantity of nodes less than the quantity of nodes in the controller cluster prior to the cluster split, then the network device 300 is able to make the determination that the cluster split has occurred.

The machine-readable instructions include sub-cluster information reception instructions 308 to receive, at the network device from the plurality of sub-clusters, information associated with controllers of the plurality of sub-clusters. The information can include sub-cluster selection information that is to be used by the network device 300 for selecting from among the plurality of sub-clusters.

The machine-readable instructions include sub-cluster selection instructions 310 to select, with the network device 300 from among the plurality of sub-clusters, a sub-cluster to which the network device is to connect using a specified criterion. More generally, the selection of the sub-cluster can use a collection of criteria, which can include a single criterion or multiple criteria.

In some examples, the specified criterion includes a criterion based on a capacity of a sub-cluster. For example, the criterion based on the capacity of the sub-cluster can include one or more of: a criterion based on a count of nodes including controllers in the sub-cluster, or a criterion based on how many stations the sub-cluster can support.

In further examples, the specified criterion includes any or some combination of: a criterion based on a network address of a sub-cluster, a criterion based on a health, a load, or a performance of a sub-cluster, or another criterion.

In some examples, the specified criterion used by the network device 300 in selecting the sub-cluster is the same criterion used by another network device in selecting from among the plurality of sub-clusters in response to the cluster split.

In some examples, use of the same criterion by the network device 300 and the other network device in selecting from among the plurality of sub-clusters causes the network device 300 and the other network device to deterministically select the same sub-cluster.

In some examples, the machine-readable instructions can determine that the cluster split has occurred based on receiving information from a sub-cluster indicating a smaller quantity of controllers in the sub-cluster than present in the controller cluster.

In some examples, responsive to determining that the cluster split has occurred, the machine-readable instructions can wait a specified time duration to receive information from other sub-clusters prior to performing the selecting.

In some examples, prior to the cluster split a plurality of network devices that connect to respective client devices are connected to the controller cluster, and where after the cluster split the plurality of network devices are connected to the selected sub-cluster, and a remainder of the plurality of sub-clusters are unused by the plurality of network devices.

In some examples, the machine-readable instructions can detect a rejoinder of the remainder of the plurality of sub-clusters with the selected sub-cluster. Rejoinder may occur if nodes of the controller cluster regain connectivity.

In some examples, the detecting of the rejoinder is based on information received from a controller in the selected sub-cluster identifying an additional controller not in the selected sub-cluster.

In some examples, after the detecting of the rejoinder, the machine-readable instructions can use a controller (e.g., a UAC) in a sub-cluster of the remainder of the plurality of sub-clusters for a communication session of a client device.

FIG. 4 is a block diagram of a non-transitory machine-readable or computer-readable storage medium 400 storing machine-readable instructions that upon execution cause a first node of a controller cluster including a plurality of nodes to perform various tasks.

The machine-readable instructions in the storage medium 400 include cluster split detection instructions 402 to detect a cluster split of the controller cluster that results in formation of a plurality of sub-clusters. The first node is part of a first sub-cluster of the plurality of sub-clusters, and the plurality of nodes include respective controllers (e.g., AACs and/or UACs) for network devices and client devices.

The machine-readable instructions in the storage medium 400 include node information generation instructions 404 to generate node information identifying nodes in the first sub-cluster, the identified nodes including the first node. The node information can be in the form of a node list, for example.

The machine-readable instructions in the storage medium 400 include sub-cluster selection information obtaining instructions 406 to obtain sub-cluster selection information from the nodes in the first sub-cluster. The sub-cluster selection information can include any or some combination of the following: information relating to a capacity of the nodes in the first sub-cluster, information of network addresses of the nodes in the first sub-cluster, information relating to a health of the nodes in the first sub-cluster, information relating to a load of the nodes in the first sub-cluster, information relating to a performance of the nodes in the first sub-cluster, or other information.

The machine-readable instructions in the storage medium 400 include sub-cluster information sending instructions 408 to send, from the first node to the network devices, sub-cluster information including the node information and the sub-cluster selection information, where the sub-cluster selection information is for use by the network devices in selecting a sub-cluster from the plurality of sub-clusters in response to the cluster split.

The sending of the node information to the network devices enables the network devices to detect an occurrence of the cluster split.

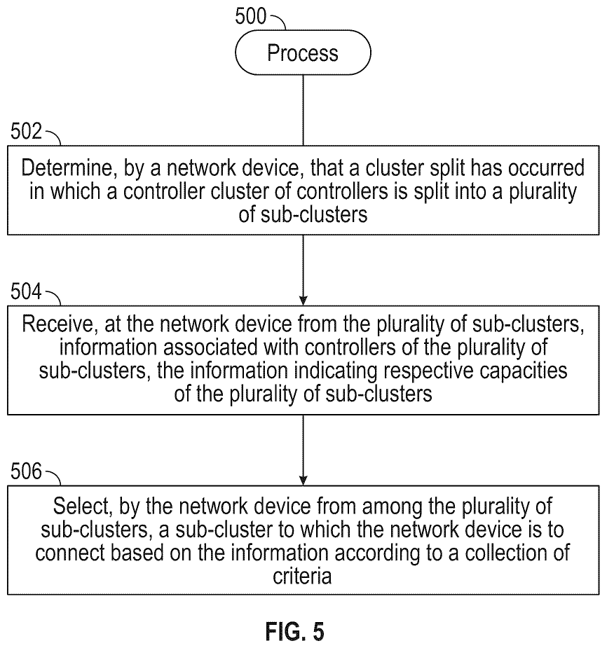

FIG. 5 is a flow diagram of a process 500 according to some examples. The process 500 may be performed by a network device such as an AP or a switch, for example.

The process 500 includes determining (at 502), by a network device, that a cluster split has occurred in which a controller cluster of controllers is split into a plurality of sub-clusters. The controller cluster can include multiple nodes in which the controllers are provided. Each sub-cluster can include a subset of the multiple nodes.

The process 500 includes receiving (at 504), at the network device from the plurality of sub-clusters, information associated with controllers of the plurality of sub-clusters, the information indicating respective capacities of the plurality of sub-clusters.

The process 500 includes selecting (at 506), by the network device from among the plurality of sub-clusters, a sub-cluster to which the network device is to connect based on the information using a collection of criteria. Multiple network devices can use the same collection of criteria such that the multiple network devices would select the same sub-cluster.

A storage medium (e.g., 304 in FIG. 3 or 400 in FIG. 4) can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A network device to connect to client devices, the network device comprising:
a processor; and
a non-transitory storage medium storing instructions executable on the processor to:
determine that a cluster split has occurred in which a controller cluster of controllers is split into a plurality of sub-clusters;
receive, at the network device from the plurality of sub-clusters, information associated with controllers of the plurality of sub-clusters; and
select, with the network device from among the plurality of sub-clusters, a sub-cluster to which the network device is to connect using a specified criterion.

2. The network device of claim 1, wherein the specified criterion used by the network device in selecting the sub-cluster is the same criterion used by another network device in selecting from among the plurality of sub-clusters in response to the cluster split.

3. The network device of claim 2, wherein use of the same criterion by the network device and the another network device in selecting from among the plurality of sub-clusters causes the network device and the another network device to deterministically select the same sub-cluster.

4. The network device of claim 1, wherein the instructions are executable on the processor to:
determine that the cluster split has occurred based on receiving information from a sub-cluster indicating a smaller quantity of controllers in the sub-cluster than present in the controller cluster.

5. The network device of claim 4, wherein the instructions are executable on the processor to:
responsive to determining that the cluster split has occurred, wait a specified time duration to receive information from other sub-clusters prior to performing the selecting.

6. The network device of claim 1, wherein prior to the cluster split a plurality of network devices that connect to respective client devices are connected to the controller cluster, and wherein after the cluster split the plurality of network devices are connected to the selected sub-cluster, and a remainder of the plurality of sub-clusters are unused by the plurality of network devices.

7. The network device of claim 6, wherein the instructions are executable on the processor to:
detect a rejoinder of the remainder of the plurality of sub-clusters with the selected sub-cluster.

8. The network device of claim 7, wherein the detecting of the rejoinder is based on information received from a controller in the selected sub-cluster identifying an additional controller not in the selected sub-cluster.

9. The network device of claim 7, wherein the instructions are executable on the processor to:
after the detecting of the rejoinder, use a controller in a sub-cluster of the remainder of the plurality of sub-clusters for a communication session of a client device.

10. The network device of claim 1, wherein the specified criterion comprises a criterion based on a capacity of a sub-cluster.

11. The network device of claim 10, wherein the criterion based on the capacity of the sub-cluster comprises one or more of:
a criterion based on a count of nodes including controllers in the sub-cluster, or
a criterion based on how many stations the sub-cluster can support.

12. The network device of claim 1, wherein the specified criterion comprises a criterion based on a network address of a sub-cluster.

13. The network device of claim 1, wherein the specified criterion comprises a criterion based on a health, a load, or a performance of a sub-cluster.

14. The network device of claim 1, comprising:
an access point (AP) to connect wirelessly to the client devices, or
a switch to establish wired connections to the client devices.

15. The network device of claim 1, wherein the network device is a first access point (AP), and wherein after the selection of the sub-cluster from among the plurality of sub-clusters in response to the cluster split, seamless roaming of a client device from a second AP to the first AP or from the first AP to the second AP is provided based on both the first AP and the second AP receiving association information from the selected sub-cluster that associates the client device with a controller of the selected sub-cluster.

16. The network device of claim 1, wherein the controllers of the controller cluster comprise a network device controller to perform management functions for the network device, and a client controller to perform management functions for the client devices.

16. A non-transitory machine-readable storage medium comprising instructions that upon execution cause a first node of a controller cluster comprising a plurality of nodes to:
detect a cluster split of the controller cluster that results in formation of a plurality of sub-clusters, wherein the first node is part of a first sub-cluster of the plurality of sub-clusters, and wherein the plurality of nodes include respective controllers for network devices and client devices;
generate node information identifying nodes in the first sub-cluster, the identified nodes including the first node;
obtain sub-cluster selection information from the nodes in the first sub-cluster; and
send, from the first node to the network devices, sub-cluster information comprising the node information and the sub-cluster selection information, wherein the sub-cluster selection information is for use by the network devices in selecting a sub-cluster from the plurality of sub-clusters in response to the cluster split.

17. The non-transitory machine-readable storage medium of claim 16, wherein the sub-cluster selection information comprises one or more of the following:
information relating to a capacity of the nodes in the first sub-cluster,
information of network addresses of the nodes in the first sub-cluster,
information relating to a health of the nodes in the first sub-cluster,
information relating to a load of the nodes in the first sub-cluster, or
information relating to a performance of the nodes in the first sub-cluster.

18. The non-transitory machine-readable storage medium of claim 16, wherein the sending of the node information to the network devices enables the network devices to detect an occurrence of the cluster split.

19. A method comprising:
determining, by a network device, that a cluster split has occurred in which a controller cluster of controllers is split into a plurality of sub-clusters;
receiving, at the network device from the plurality of sub-clusters, information associated with controllers of the plurality of sub-clusters, the information indicating respective capacities of the plurality of sub-clusters; and
selecting, by the network device from among the plurality of sub-clusters, a sub-cluster to which the network device is to connect based on the information according to a collection of criteria.

20. The method of claim 19, wherein the information associated with the controllers of the plurality of sub-clusters further comprise one or more of the following:
information of network addresses of nodes containing the controllers in the plurality of sub-clusters,
information relating to a health of the nodes in the plurality of sub-clusters,
information relating to a load of the nodes in the plurality of sub-clusters, or
information relating to a performance of the nodes in the plurality of sub-clusters.
